(19) United States
(12) Patent Application Publication
(10) Pub. No.: US 2025/0362917 A1
(43) Pub. Date: Nov. 27, 2025

(54) CPU CAPABLE OF QUICKLY PROCESSING MEMORY COPY INSTRUCTION AND METHOD THEREFOR

(71) Applicant: NANJING QINHENG MICROELECTRONICS CO., LTD, Nanjing (CN)

(72) Inventors: Qinghe QUE, Nanjing (CN); Yong YANG, Nanjing (CN)

(73) Assignee: NANJING QINHENG MICROELECTRONICS CO., LTD, Nanjing (CN)

(21) Appl. No.: 19/290,425

(22) Filed: Aug. 5, 2025

(30) Foreign Application Priority Data
Aug. 7, 2024 (CN) 2024110749157

(51) Int. Cl. G06F 9/30; G06F 12/02

(52) U.S. Cl. CPC G06F 9/3016; G06F 9/30043; G06F 12/0223

(57) ABSTRACT

Disclosed are a CPU capable of quickly processing a memory copy instruction and a method therefor, the CPU comprises: an instruction decoder, a general-purpose register, a memory copy controller, a bus interface, a buffer, an adder and a comparator, the memory copy controller comprises a state machine, the state machine comprises an idle state, a read state and a write state, and in the idle state, the instruction decoder waits for receiving a valid memory copy instruction; in the read state, data of a source address are read through the bus interface and the data are temporarily stored in the buffer; and in the write state, the temporarily stored data from the buffer are written to a target address through the bus interface, the adder is used for updating the address, and the comparator is used for judging whether memory copy is finished.

### CROSS-REFERENCE TO RELATED APPLICATIONS

This application claims priority to Chinese Patent Application Ser. No. CN2024110749157 filed on 7 Aug. 2024

### TECHNICAL FIELD

The present invention belongs to the technical field of computers, and particularly relates to a CPU capable of quickly processing a memory copy instruction and a method therefor.

### BACKGROUND

Memory copy (memcpy) is a simple and diverse operation, which is generally achieved by two methods: a software method and a hardware method.

The software method can be achieved by many kinds of codes, but it is necessary to run a loop body program and fetch instructions repeatedly in all of them, causing higher power consumption; meanwhile, an overall copy performance is affected by an instruction bus latency; in a case that branch instruction prediction of a CPU fails, bubbles will be introduced into a pipeline, which reduces the execution efficiency; it is necessary to select a smallest value among a number of bytes of source address alignment, a number of bytes of target address alignment and a width of a CPU register as a maximum number of bytes (n) in single copy, so that memory copy of any address has large delay fluctuation; and because the single copy is limited by a maximum width of the CPU register, a bandwidth of a storage cannot be utilized to the greatest extent, leading to the low memory copy efficiency.

The hardware method is achieved depending on DMA, but the DMA generally does not support any alignment mode of the source/target address; in addition, the software needs to wait until the last DMA is finished before it may perform the next DMA, and it is impossible to suspend the DMA in scenarios such as interruption/thread switching; and in addition, the DMA is a non-standard hardware resource, and DMA usage modes and register addresses designed by various design manufacturers are din a case thatferent, so that the software method is often used for memory copy of an application program that needs to ensure compatibility, such as an operating system, a protocol stack and a system library.

### SUMMARY

Objective of the invention: in order to solve the problem of low memory copy efficiency in the prior art, the present invention provides a CPU capable of quickly processing a memory copy instruction and a method therefor.

Technical solution: a CPU capable of quickly processing a memory copy instruction comprises:
an instruction decoder, which has an input terminal for inputting a CPU instruction and an output terminal connected with a read port of a general-purpose register and a memory copy controller, and is used for decoding a valid memory copy instruction, wherein the valid memory copy instruction comprises a source address register label, a target address register label and a copy end information register label;
the general-purpose register, which is connected with the memory copy controller, and used for storing a source address, a target address and copy end information;
the memory copy controller, which comprises a state machine, wherein the state machine comprises an idle state, a read state and a write state, and in the idle state, the instruction decoder waits for receiving a valid memory copy instruction; in the read state, a bus interface is controlled to read data from the source address and the data are temporarily stored in a buffer; and in the write state, the bus interface is controlled to write the temporarily stored data from the buffer to the target address;
the bus interface, which is connected with the memory copy controller and the buffer, and externally connected with an external storage;
the buffer, which is connected with the memory copy controller;
an adder, which has an input terminal connected with the read port of the general-purpose register and the memory copy controller, and an output terminal connected with a write port of the general-purpose register, and is used for updating the source address and the target address; and
a comparator, which has an input terminal connected with the read port of the general-purpose register and an output terminal connected with the memory copy controller, and is used for judging whether memory copy is finished according to the copy end information.

Further, a space of the buffer is M*2^{N} bytes, wherein M is a positive integer and 2^{N} is a width of the bus interface.

Further, the copy end information is one or more of an end address of the source address, an end address of the target address and a total copy length.

Further, one state machine, one adder and one bus interface are provided respectively; one write port of the general-purpose register is occupied for time-sharing writing of updated source address or target address; two read ports of the general-purpose register are occupied, wherein a first read port is used for reading the copy end information, and a second read port is used for time-sharing reading of current source address and target address; a first selector is further provided, wherein two input terminals of the first selector respectively input the source address register label and the target address register label, a control end is connected with the memory copy controller, and an output terminal is connected with the second read port and the write port of the general-purpose register; in the read state, the first selector outputs the source address register label; and in the write state, the first selector outputs the target address register label.

Further, two state machines, two adders and two bus interfaces are provided respectively, comprising a read state machine, a read adder and a read bus interface which are used for a read operation, and a write state machine, a write adder and a write bus interface which are used for a write operation, wherein the read state machine contains an idle state and a read state, and the write state machine contains an idle state and a write state; two write ports of the general-purpose register are occupied for writing the updated source address and target address respectively; and three read ports of the general-purpose register are occupied, wherein a first read port, a second read port and a third read port are used for reading the copy end information, the source address and the target address respectively.

A method for quickly processing a memory copy instruction by using the CPU capable of quickly processing the memory copy instruction above comprises the following steps of:
allowing the state machine of the memory copy controller to be in the idle state initially;
when the instruction decoder receives the valid memory copy instruction, reading the source address register label, the target address register label and the copy end information register label from the valid memory copy instruction to the general-purpose register, sending an actuating signal to the memory copy controller at the same time, and obtaining and outputting, by the general-purpose register, initial values of the source address and the target address and the copy end information through the source address register label, the target address register label and the copy end information register label; and
when the memory copy controller receives the actuating signal, allowing the state machine to jump to the read state, reading the data from the source address through the bus interface and temporarily storing the data in the buffer, and allowing the state machine to jump to the write state after reading the data at least once; in the write state, writing the data in the buffer to the target address in sequence according to a principle of first-in, first-out through the bus interface, clearing written data in the buffer, and allowing the state machine to jump to the read state after writing the data at least once; and constantly switching the state machine between the read state and the write state, updating the source address and the target address by the adder, judging whether memory copy is finished by the comparator according to the copy end information, and allowing the state machine to return to the idle state in a case that memory copy is finished.

Further, in the read state, 1-2^{N} bytes of data are read each time; and in the write state, 1-2^{N} bytes of data are written each time, and 2^{N} is the width of the bus interface.

Further, in the read state, in a case that a vacant bit of the buffer is less than 2^{N} bytes, the state machine jumps to the write state, and in a case that the vacant bit of the buffer is not less than 2^{N} bytes, the state machine remains in the read state; and in the write state, in a case that a signin a case thaticant bit of the buffer is less than 2^{N} bytes, the state machine jumps to the read state, and in a case that the signin a case thaticant bit of the buffer is not less than 2^{N} bytes, the state machine remains in the write state.

Further, a method for judging whether memory copy is finished according to the copy end information comprises:
in the read state, pre-judging whether the read operation is about to be finished by the comparator according to the source address and the copy end information, in a case that the read operation is about to be finished, allowing the state machine to enter an empty state instead of the write state after reading, and in a case that the read operation is not about to be finished, executing the read operation normally and jumping to the write operation; and
in the empty state, writing the data in the buffer to the target address, clearing the written data until the buffer is empty, and finishing memory copy.

Further, in a case that the state machine is in a non-idle state, when the memory copy controller receives an interrupt request signal or a debugging signal of the instruction decoder, the state machine jumps to the empty state first, and after the state machine returns to the idle state, a processor normally responds to an interrupt or debugging request; in a case that the state machine is in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.

A method for quickly processing a memory copy instruction by using the CPU capable of quickly processing the memory copy instruction above comprises the following steps of:
allowing both of the read state machine and the write state machine of the memory copy controller to be in the idle state initially;
when the instruction decoder receives the valid memory copy instruction, reading the source address register label, the target address register label and the copy end information register label from the valid memory copy instruction to the general-purpose register, sending an actuating signal to the memory copy controller at the same time, and obtaining and outputting, by the general-purpose register, initial values of the source address and the target address and the copy end information through the source address register label, the target address register label and the copy end information register label;
after the memory copy controller receives the actuating signal, allowing the read state machine to jump to the read state, constantly reading the data from the source address through the read bus interface and temporarily storing the data in the buffer, updating the source address by the read adder until the read operation is ended, and allowing the read state machine to jump to the idle state; and
meanwhile, allowing the write state machine of the memory copy controller to jump to the write state, writing the data in the buffer to the target address in sequence according to a principle of first-in, first-out through the write bus interface, clearing the written data in the buffer, updating the target address by the write adder until the write operation is ended, and allowing the write state machine to jump to the idle state.

Further, in the read state, 1-2^{N} bytes of data are read each time; and in the write state, 1-2^{N} bytes of data are written each time, and 2^{N} is the width of the bus interface.

Further, a method for judging whether the read operation is ended comprises: judging whether the read operation is finished according to the source address and the copy end information by the comparator; and
a method for judging whether the write operation is ended comprises: when the read state machine is in the idle state, in a case that the buffer is empty, finishing the write operation; and in a case that the buffer is not empty, continuing to perform the write operation until the buffer is empty; and when the read state machine is in a non-idle state, allowing the write state machine to remain in the write state all the time.

Further, in a case that at least one of the read state machine and the write state machine is in the non-idle state, when the memory copy controller receives an interrupt request signal or a debugging signal of the instruction decoder, the read state machine jumps to the idle state first, and after the write state machine also jumps to the idle state, a processor normally responds to an interrupt or debugging request; in a case that both of the read state machine and the write state machine are in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.

Compared with the prior art, the CPU capable of quickly processing the memory copy instruction and the method therefor provided by the present invention have the following beneficial effects:
(1) a bandwidth of a storage can be utilized to the maximum extent, and the memory copy efficiency can be greatly improved;
(2) there is no requirement for a source address alignment mode and a target address alignment mode, and any alignment mode is supported;
(3) there is no branch instruction overhead;
(4) interruption is supported, and the operation returns to continue unfinished memory copy after interrupt processing;
(5) repeated instruction fetching is avoided, the instruction fetching power consumption is reduced, and the influence of the instruction bus latency is avoided; and
(6) an original logic unit of the CPU may be fully multiplexed, with few new units and a simple structure. For example, the adder, the comparator and the bus interface can be achieved by multiplexing original functional units in the CPU, and the selector is added to select an instruction or an original path for memory copy.

### BRIEF DESCRIPTION OF THE DRAWINGS

FIG. 1 is a schematic structural diagram of a CPU capable of quickly processing a memory copy instruction in First Embodiment;

FIG. 2 is a diagram showing a change of data in a buffer during memory copy; and

FIG. 3 is a schematic structural diagram of a CPU capable of quickly processing a memory copy instruction in Second Embodiment.

### DETAILED DESCRIPTION

The present invention is further explained and described hereinafter with reference to the drawings and specin a case thatic embodiments.

### First Embodiment

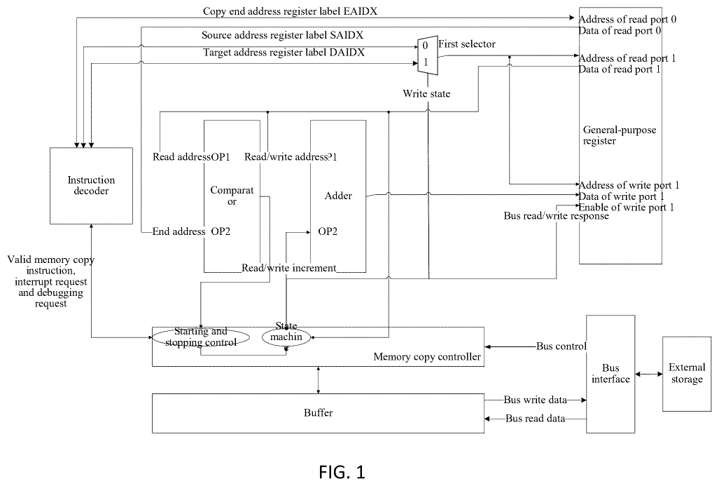

A CPU capable of quickly processing a memory copy instruction, as shown in FIG. 1, comprises an instruction decoder (DEC), a memory copy controller, a general-purpose register (GPR), a bus interface, a buffer, an adder and a comparator.

The instruction decoder has an input terminal for inputting a CPU instruction and an output terminal connected with a read port of a general-purpose register and a memory copy controller, and is used for decoding a valid memory copy instruction, wherein the valid memory copy instruction comprises a source address register label, a target address register label and a copy end information register label. Storage locations of a source address, a target address and copy end information in the general-purpose register may be obtained through the source address register label, the target address register label and the copy end information register label.

The memory copy controller comprises a state machine, wherein the state machine comprises an idle state, a read state and a write state, and in the idle state, the instruction decoder waits for receiving a valid memory copy instruction; in the read state, data from the source address are read through a bus interface and the data are temporarily stored in a buffer; and in the write state, the temporarily stored data from the buffer are written to the target address through the bus interface.

The general-purpose register is connected with the memory copy controller, and used for storing the source address and the target address. In this embodiment, the general-purpose register comprises a write port 1 (an address of the write port 1, data of the write port 1 and enable of the write port 1) and two read ports, which are a read port 0 (an address of the read port 0 and data of the read port 0) and a read port 1 (an address of the read port 1 and data of the read port 1). The address of the write port 1 is used for writing the source address or target address register label, the data of the write port 1 are used for writing the source address or the target address that is updated by the adder, and the enable of the write port 1 is connected with the memory copy controller for controlling write enable of the write port 1. The address of the read port 1 is selected to read the source address register label or the target address register label under the selection of the selector, and the address of the read port 0 is used to read the copy end information, wherein the copy end information may be a total copy length or an end address (the end address comprises an end address relative to the source address and an end address relative to the target address), for example, the copy end information is the end address of the source address in this embodiment.

The general-purpose register is a register file for storing temporary results inside the CPU, in which the source address, the target address and the copy end information are pre-stored. In the memory copy instruction, the source address register label points to a certain register in the GPR, and a corresponding value of this register is an initial value of the source address, which is a first read address; the target address register label points to a certain register in the GPR, a corresponding value of this register is an initial value of the target address, which is a first write address; and the copy end information register label points to a certain register in the GPR, and a corresponding value of this register is the end address of the source address. In a working process of the memory copy controller, the adder may update the source address/target address according to a number of bytes read/written each time (a read/write increment). in a case that the copy end information is the total copy length, a remaining copy length needs to be updated in each read/write operation. The controller will write the latest read address to the register pointed by the source address register label SA_IDX, write the latest write address to the register pointed by the target address register label DA_IDX, and write the latest copy end information to the register pointed by the copy end information register label EA_IDX in real time. That is, the register pointed by the SA_IDX reflects the latest read address constantly, the register pointed by the DA_IDX reflects the latest write address constantly, and the register pointed by the EA_IDX reflects the latest copy end information constantly. Read and write state machines respectively access a memory by this address and generate an end signal.

The bus interface is connected with the memory copy controller and the buffer, receives read and write requests of the memory copy controller, and feeds back a bus response, and the bus interface is externally connected with an external storage. The memory copy controller controls the bus interface to perform the read/write operation on the external storage according to a current source address/target address.

The buffer is connected with the memory copy controller, wherein a space of the buffer is M*2^{N} bytes, wherein M is a positive integer and 2^{N} is a width of the bus interface. For example, in this embodiment, the width of the bus interface is 4 bytes, the space of the buffer is 8 bytes, and M is 2.

The adder has one input terminal connected with the data (the source address/target address) of the read port 1 of the general-purpose register and the other input terminal connected with the memory copy controller, wherein the memory copy controller provides an address increment for updating the source address and the target address. For example, in the read state, 4 bytes of data are read each time, and the source address needs +4 bytes, so that the increment is 4 bytes. The source address updated by the adder is an offset address, and is written back to the general-purpose register through an output terminal of the adder, or written back through a write-back unit (WB). The target address is updated in the same way. The adder performs time division multiplexing through a first selector, two input terminals of the first selector are respectively connected with the source address register label and the target address register label, a control end is connected with the memory copy controller, and an output terminal is connected with the general-purpose register; in the read state, the first selector outputs the source address register label; and in the write state, the first selector outputs the target address register label. Therefore, this embodiment needs to be achieved by one adder matched with the selector.

The comparator has one input terminal connected with the data (the source address/target address) of the read port 1 of the general-purpose register, wherein the comparison is only performed when the source address is input in this solution; the other input terminal connected with the data (the end address of the source address) of the read port 0 of the general-purpose register; and an output terminal connected with the memory copy controller, and is used for judging whether memory copy is finished.

In this embodiment, one adder, one comparator and one bus interface are provided respectively, and one write port of the general-purpose register is occupied; and a first selector is further provided.

When it needs to be used in the read state and the write state respectively, the first selector is also provided. When it needs to be used in the read state and the write state respectively, the first selector is used for time division multiplexing. In addition, the adder, the comparator and the bus interface can also be achieved by multiplexing original functional units in the CPU, and the selector is added to select an instruction or an original path for memory copy, so that the structure is simpler. Therefore, the connection between various parts in the CPU comprises direct connection and indirect connection.

In this embodiment, the memory copy controller only contains one state machine, and this state machine comprises at least an idle state, a read state and a write state, and may also comprise an empty state, which is used when it is judged that memory copy is finished.

A method for quickly processing a memory copy instruction by using the CPU capable of quickly processing the memory copy instruction above comprises the following steps of:
allowing the state machine of the memory copy controller to be in the idle state initially;
when the instruction decoder receives the valid memory copy instruction, reading the source address register label, the target address register label and the copy end information register label from the valid memory copy instruction to the general-purpose register, sending an actuating signal to the memory copy controller at the same time, and obtaining and outputting, by the general-purpose register, initial values of the source address and the target address and the copy end information through the source address register label, the target address register label and the copy end information register label; and
when the memory copy controller receives the actuating signal, allowing the state machine to jump to the read state, reading the data from the source address through the bus interface and temporarily storing the data in the buffer, wherein 1˜2^{N} bytes of data are read each time. and allowing the state machine to jump to the write state after reading the data at least once; in the write state, writing the data in the buffer to the target address in sequence according to a principle of first-in, first-out through the bus interface, clearing written data in the buffer, wherein 1˜2^{N} bytes of data are written each time, and allowing the state machine to jump to the read state after writing the data at least once; and constantly switching the state machine between the read state and the write state, updating the source address and the target address by the adder, judging whether memory copy is finished by the comparator according to the copy end information, and allowing the state machine to return to the idle state in a case that memory copy is finished.

In order to maximize the memory copy efficiency, a priority of the read operation is generally higher than that of the write operation, that is, in the read state, in a case that a vacant bit of the buffer is less than 2^{N} bytes, the state machine jumps to the write state, and in a case that the vacant bit of the buffer is not less than 2^{N} bytes, the state machine remains in the read state; and in the write state, in a case that a signin a case thaticant bit of the buffer is less than 2^{N} bytes, the state machine jumps to the read state, and in a case that the signin a case thaticant bit of the buffer is not less than 2^{N} bytes, the state machine remains in the write state, wherein vacant bit+signin a case thaticant bit=M*2^{N}. In this way, it is ensured that there is no idle waiting time in a read and write switching process, which can maximize the memory copy efficiency.

Whether memory copy is finished may be judged in the read state or in the write state, preferably in the read state, and at this time, it is necessary to set a fourth state, which is the empty state. A method specin a case thatically comprises:
in the read state, pre-judging whether the read operation is about to be finished by the comparator according to the source address and the copy end information (the end address of the source address), wherein the pre-judging refers to judging whether the source address after reading reaches or exceeds the end address first before starting this read operation, in a case that the read operation is about to be finished, considering that the read operation is about to be finished after reading the data once, and allowing the state machine to enter the empty state instead of the write state after the read operation, and in a case that the read operation is not about to be finished, executing the read operation normally and jumping to the write operation; and
in the empty state, writing the data in the buffer to the target address, clearing the written data until the buffer is empty, and finishing memory copy. The empty state is din a case thatferent from the write state in that: in the write state, the state machine may jump to the read state because the vacant bit of the buffer reaches or exceeds 2^{N} bytes, while in the empty state, all the data in the buffer will be written until the state machine jumps to the idle state after emptying the buffer.

This embodiment supports interruption. in a case that the state machine is in a non-idle state, when the memory copy controller receives an interrupt request signal or a debugging signal of the instruction decoder, the state machine jumps to the empty state first, and after the state machine returns to the idle state, a processor normally responds to an interrupt or debugging request; in a case that the state machine is in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.

In addition to the method of setting the empty state, the same effect can also be achieved through an end mark, and when the end mark is valid, it is equivalent to entering the empty state. Pre-judging comparison is performed before reading each time, and in a case that the pre-judging result is that the read operation is about to be finished, the end mark is recorded as being valid; and in a case that the read operation is not about to be finished, the end mark is recorded as being invalid. The state machine is switched to the write state after the read state, and when the end mark is valid, all the data in the buffer will be written in the write state and the buffer will be emptied, and the state machine will not jump to the read state again; and when the end mark is invalid, the write state refers to an ordinary write operation, and the state machine still needs to jump to the read state according to the vacant bit of the buffer after the write operation.

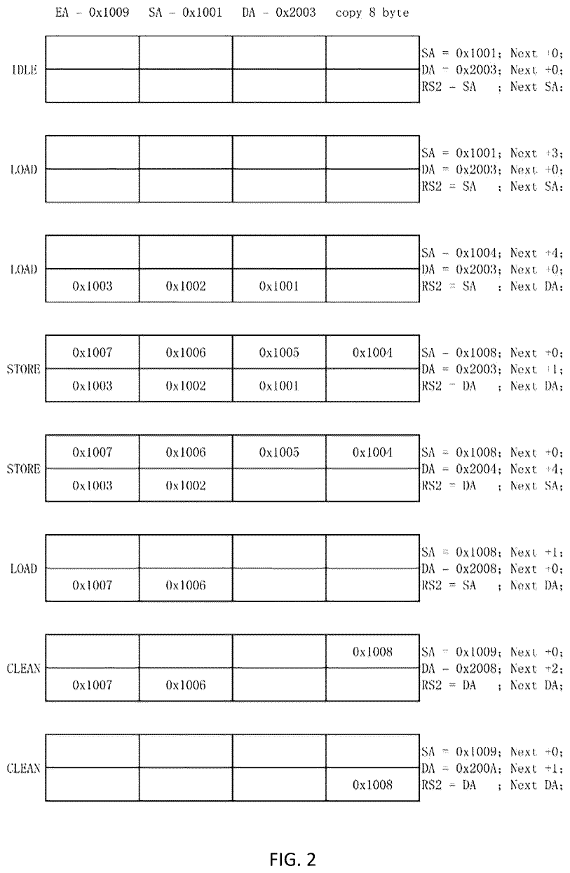

A diagram showing a change of the data in the buffer in one memory copy operation is as shown in FIG. 2. In this case, EA=0x1009, SA=0x1001, DA=0x2003, and a total copy length is 8 bytes. IDLE refers to the idle state, LOAD refers to the read state, STORE refers to the write state, and CLEAN refers to the empty state. In the read state, 4 bytes of data are read each time, and the data may also be marked; and the write state is achieved by a maximum alignment principle (a maximum size principle).

In this embodiment, a maximum number of bytes in a single read operation can reach the width 2^{N} of the bus interface, and the write operation may be performed by the maximum alignment principle, which is not limited, so that the memory copy efficiency can be improved as much as possible.

### Second Embodiment

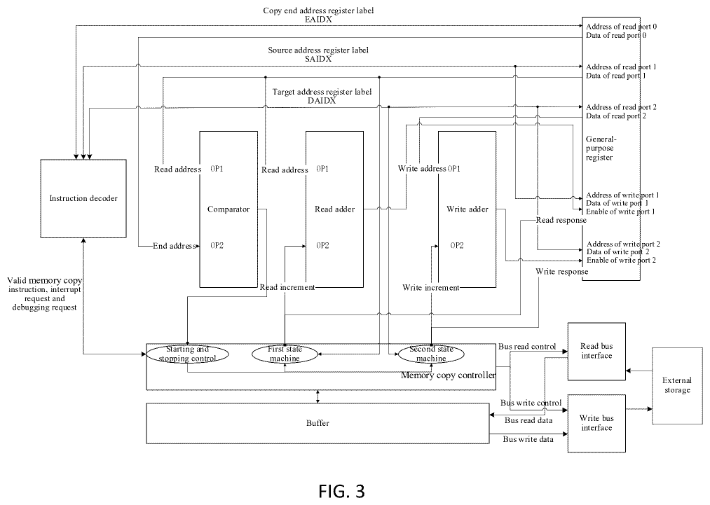

Second Embodiment is din a case thatferent from First Embodiment in that: in Second Embodiment, the read and write operations may be performed at the same time. As shown in FIG. 3, in this case, the memory copy controller needs two state machines for controlling the read operation and the write operation respectively, comprising a read state machine and a write state machine, wherein the read state machine contains an idle state and a read state for the read operation; and the write state machine contains an idle state and a write state for the write operation. In this embodiment, the read and write operations may be performed at the same time, so that the memory copy efficiency is higher.

In addition to the state machines, two adders and two bus interfaces are provided respectively, comprising a read adder and a read bus interface which are used for the read operation, and a write adder and a write bus interface which are used for the write operation. It is necessary to occupy two write ports and three read ports of the general-purpose register. One input terminal of the read adder is connected with the data of the read port 1 of the general-purpose register, the other input terminal is connected with the read state machine of the memory copy controller (for acquiring a read increment), and an output terminal is connected with the data of the write port 1. One input terminal of the write adder is connected with the data of the read port 2 of the general-purpose register, the other input terminal is connected with the write state machine of the memory copy controller (for acquiring a write increment), and an output terminal is connected with the data of the write port 2. The address of the read port 1 and the address of the write port 1 of the general-purpose register are both connected with SA_IDX, the address of the read port 2 and the address of the write port 2 are both connected with DA_IDX, and the address of the read port 0 is connected with SA_IDX. The enable of the write port 1 is connected with the read state machine for controlling the write enable of the write port 1, and the enable of the write port 2 is connected with the write state machine for controlling the write enable of the write port 2.

A method for quickly processing a memory copy instruction by using the CPU capable of quickly processing the memory copy instruction above comprises the following steps of:
allowing both of the read state machine and the write state machine of the memory copy controller to be in the idle state initially;
when the instruction decoder receives the valid memory copy instruction, reading the source address register label, the target address register label and the copy end information register label from the valid memory copy instruction to the general-purpose register, obtaining initial values of the source address and the target address and the copy end information through the source address register label, the target address register label and the copy end information register label, sending an actuating signal to the memory copy controller at the same time, and simultaneously performing the read operation and the write operation;
allowing the read state machine of the memory copy controller to jump to the read state, constantly reading the data from the source address through the read bus interface and temporarily storing the data in the buffer, updating the source address by the read adder until the read operation is ended, and allowing the read state machine to jump to the idle state; and
meanwhile, allowing the write state machine of the memory copy controller to jump to the write state, writing the data in the buffer to the target address through the write bus interface, clearing the written data in the buffer, updating the target address by the write adder until the write operation is ended, and allowing the write state machine to jump to the idle state.

A method for judging whether the read operation is ended comprises: judging whether the read operation is finished according to the source address and the copy end information by the comparator.

A method for judging whether the write operation is ended comprises: when the read state machine is in the idle state, in a case that the buffer is empty, finishing the write operation; and in a case that the buffer is not empty, continuing to perform the write operation until the buffer is empty; and when the read state machine is in a non-idle state, allowing the write state machine to remain in the write state all the time.

This embodiment supports interruption. in a case that at least one of the read state machine and the write state machine is in the non-idle state, when the memory copy controller receives an interrupt request signal or a debugging signal of the instruction decoder, the read state machine jumps to the idle state first, and after the write state machine also jumps to the idle state, a processor normally responds to an interrupt or debugging request; in a case that both of the read state machine and the write state machine are in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.

What is claimed is:

1. A CPU capable of quickly processing a memory copy instruction, comprising:
an instruction decoder, which has an input terminal for inputting a CPU instruction and an output terminal connected with a read port of a general-purpose register and a memory copy controller, and is used for decoding a valid memory copy instruction, wherein the valid memory copy instruction comprises a source address register label, a target address register label and a copy end information register label;
the general-purpose register, which is connected with the memory copy controller, and used for storing a source address, a target address and copy end information;
the memory copy controller, which comprises a state machine, wherein the state machine comprises an idle state, a read state and a write state, and in the idle state, the instruction decoder waits for receiving a valid memory copy instruction; in the read state, a bus interface is controlled to read data from the source address and the data are temporarily stored in a buffer; and in the write state, the bus interface is controlled to write the temporarily stored data from the buffer to the target address;
the bus interface, which is connected with the memory copy controller and the buffer, and externally connected with an external storage;
the buffer, which is connected with the memory copy controller;
an adder, which has an input terminal connected with the read port of the general-purpose register and the memory copy controller, and an output terminal connected with a write port of the general-purpose register, and is used for updating the source address and the target address; and
a comparator, which has an input terminal connected with the read port of the general-purpose register and an output terminal connected with the memory copy controller, and is used for judging whether memory copy is finished according to the copy end information.

2. The CPU capable of quickly processing the memory copy instruction according to claim 1, wherein a space of the buffer is M*2^{N} bytes, wherein M is a positive integer and 2^{N} is a width of the bus interface.

3. The CPU capable of quickly processing the memory copy instruction according to claim 1, wherein the copy end information is one or more of an end address of the source address, an end address of the target address and a total copy length.

4. The CPU capable of quickly processing the memory copy instruction according to claim 1, wherein one state machine, one adder and one bus interface are provided respectively; one write port of the general-purpose register is occupied for time-sharing writing of updated source address or target address; two read ports of the general-purpose register are occupied, wherein a first read port is used for reading the copy end information, and a second read port is used for time-sharing reading of current source address and target address; a first selector is further provided, wherein two input terminals of the first selector respectively input the source address register label and the target address register label, a control end is connected with the memory copy controller, and an output terminal is connected with the second read port and the write port of the general-purpose register; in the read state, the first selector outputs the source address register label; and in the write state, the first selector outputs the target address register label.

5. The CPU capable of quickly processing the memory copy instruction according to claim 1, wherein two state machines, two adders and two bus interfaces are provided respectively, comprising a read state machine, a read adder and a read bus interface which are used for a read operation, and a write state machine, a write adder and a write bus interface which are used for a write operation, wherein the read state machine contains an idle state and a read state, and the write state machine contains an idle state and a write state; two write ports of the general-purpose register are occupied for writing the updated source address and target address respectively; and three read ports of the general-purpose register are occupied, wherein a first read port, a second read port and a third read port are used for reading the copy end information, the source address and the target address respectively.

6. A method for quickly processing a memory copy instruction by using the CPU capable of quickly processing the memory copy instruction according to claim 1, comprising the following steps of:
allowing the state machine of the memory copy controller to be in the idle state initially;
when the instruction decoder receives the valid memory copy instruction, reading the source address register label, the target address register label and the copy end information register label from the valid memory copy instruction to the general-purpose register, sending an actuating signal to the memory copy controller at the same time, and obtaining and outputting, by the general-purpose register, initial values of the source address and the target address and the copy end information through the source address register label, the target address register label and the copy end information register label; and
when the memory copy controller receives the actuating signal, allowing the state machine to jump to the read state, reading the data from the source address through the bus interface and temporarily storing the data in the buffer, and allowing the state machine to jump to the write state after reading the data at least once; in the write state, writing the data in the buffer to the target address in sequence according to a principle of first-in, first-out through the bus interface, clearing written data in the buffer, and allowing the state machine to jump to the read state after writing the data at least once; and constantly switching the state machine between the read state and the write state, updating the source address and the target address by the adder, judging whether memory copy is finished by the comparator according to the copy end information, and allowing the state machine to return to the idle state in a case that memory copy is finished.

7. The method for quickly processing the memory copy instruction according to claim 6, wherein, in the read state, 1-2^{N} bytes of data are read each time; and in the write state, 1-2^{N} bytes of data are written each time, and 2^{N} is the width of the bus interface.

8. The method for quickly processing the memory copy instruction according to claim 7, wherein, in the read state, in a case that a vacant bit of the buffer is less than 2^{N} bytes, the state machine jumps to the write state, and in a case that the vacant bit of the buffer is not less than 2^{N} bytes, the state machine remains in the read state; and in the write state, in a case that a signin a case thaticant bit of the buffer is less than 2^{N} bytes, the state machine jumps to the read state, and in a case that the signin a case thaticant bit of the buffer is not less than 2^{N} bytes, the state machine remains in the write state.

9. The method for quickly processing the memory copy instruction according to claim 6, wherein a method for judging whether memory copy is finished according to the copy end information comprises:
in the read state, pre-judging whether the read operation is about to be finished by the comparator according to the source address and the copy end information, in a case that the read operation is about to be finished, allowing the state machine to enter an empty state instead of the write state after reading, and in a case that the read operation is not about to be finished, executing the read operation normally and jumping to the write operation; and
in the empty state, writing the data in the buffer to the target address, clearing the written data until the buffer is empty, and finishing memory copy.

10. The method for quickly processing the memory copy instruction according to claim 9, wherein, in a case that the state machine is in a non-idle state, when the memory copy controller receives an interrupt request signal or a debugging signal of the instruction decoder, the state machine jumps to the empty state first, and after the state machine returns to the idle state, a processor normally responds to an interrupt or debugging request; in a case that the state machine is in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.

11. A method for quickly processing a memory copy instruction by using the CPU capable of quickly processing the memory copy instruction according to claim 1, comprising the following steps of:
allowing both of the read state machine and the write state machine of the memory copy controller to be in the idle state initially;
when the instruction decoder receives the valid memory copy instruction, reading the source address register label, the target address register label and the copy end information register label from the valid memory copy instruction to the general-purpose register, sending an actuating signal to the memory copy controller at the same time, and obtaining and outputting, by the general-purpose register, initial values of the source address and the target address and the copy end information through the source address register label, the target address register label and the copy end information register label;
after the memory copy controller receives the actuating signal, allowing the read state machine to jump to the read state, constantly reading the data from the source address through the read bus interface and temporarily storing the data in the buffer, updating the source address by the read adder until the read operation is ended, and allowing the read state machine to jump to the idle state; and
meanwhile, allowing the write state machine of the memory copy controller to jump to the write state, writing the data in the buffer to the target address in sequence according to a principle of first-in, first-out through the write bus interface, clearing the written data in the buffer, updating the target address by the write adder until the write operation is ended, and allowing the write state machine to jump to the idle state.

12. The method for quickly processing the memory copy instruction according to claim 11, wherein, in the read state, 1-2^{N} bytes of data are read each time; and in the write state, 1-2^{N} bytes of data are written each time, and 2^{N} is the width of the bus interface.

13. The method for quickly processing the memory copy instruction according to claim 11, wherein a method for judging whether the read operation is ended comprises: judging whether the read operation is finished according to the source address and the copy end information by the comparator; and
a method for judging whether the write operation is ended comprises: when the read state machine is in the idle state, in a case that the buffer is empty, finishing the write operation; and in a case that the buffer is not empty, continuing to perform the write operation until the buffer is empty; and when the read state machine is in a non-idle state, allowing the write state machine to remain in the write state all the time.

14. The method for quickly processing the memory copy instruction according to claim 13, wherein, in a case that at least one of the read state machine and the write state machine is in the non-idle state, when the memory copy controller receives an interrupt request signal or a debugging signal of the instruction decoder, the read state machine jumps to the idle state first, and after the write state machine also jumps to the idle state, a processor normally responds to an interrupt or debugging request; in a case that both of the read state machine and the write state machine are in the idle state, when the memory copy controller receives the interrupt request signal or the debugging signal of the instruction decoder, the processor normally responds to the interrupt or debugging request; in a process of interrupt or debugging response, a return program pointer is saved as a program pointer of a current memory copy instruction, and the general-purpose register performs software and hardware saving and recovery according to an application program binary interface; and after exiting interruption or debugging, the program pointer is restored to the return program pointer, and the processor re-executes the memory copy instruction and continues to execute from a memory copy breakpoint to finish the remaining memory copy.
